(19) United States
(12) Patent Application Publication
(10) Pub. No.: US 2004/0267914 A1
(43) Pub. Date: Dec. 30, 2004

(54) Method, apparatus and system for creating efficient UPnP control points

(76) Inventors: Bryan Y. Roe, Camas, WA (US); Ylian Saint-Hilaire, Hillsboro, OR (US); Nelson F. Kidd, Camas, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,617

(22) Filed: Jun. 30, 2003

(51) Int. Cl. G06F 15/177

(52) U.S. Cl. 709/222

(57) ABSTRACT

Enhanced Universal Plug and Play (“UPnP”) control points may be generated. According to one embodiment, a variety of device-specific information (e.g., device and service descriptions) and platform information may be used to generate custom source code for an UPnP control point. The source code may be enhanced for the control point. The source code may then be compiled to generate the enhanced UPnP control point.

### FIELD OF THE INVENTION

The present invention relates to the field of networking, and, more particularly to a method, apparatus and system for creating efficient Universal Plug and Play (“UPnP”) control points.

### BACKGROUND

Universal Plug and Play (“UPnP”) provides an architecture for peer-to-peer network connectivity. UPnP-compliant devices may dynamically join a network, obtain a network address, convey their capabilities to the network and learn about the presence and capabilities of other devices on the network. UPnP control points control UPnP devices by requesting the devices to perform specified actions (“services”).

In order to build UPnP compliant control points, control point vendors today typically acquire (e.g., purchase) generic prepackaged UPnP stacks and build control point specific portions of code on top of the generic stacks (these control point stacks, including the generic prepackaged UPnP stack, are hereafter referred to as “Control Point Stacks”). The concept of “stacks” is well known to those of ordinary skill in the art and further description thereof is omitted herein. Control point stacks today are likely to be written using a relatively complex Extensible Markup Language (“XML”) parser. An “XML Parser” is a code module capable of encoding and decoding XML. XML is a World Wide Web Consortium (“WC3”) promulgated standard markup language that allows users to generate tags for their files. The tags enable computers (and humans) to interpret the contents of the file.

UPnP Control Point Stacks are likely to be large because they are built on generic UPnP stacks that include significant amounts of unnecessary code for a specific control point type. For example, a generic UPnP stack may include features usable by control points to control Devices A, B and C, but a control point vendor may only require a subset of the features for a particular control point (e.g., to control Device A). The control point vendor nonetheless includes all the features when building the Control Point Stack because the generic stack must include all possible features. Additionally, a generic Control Point Stack today is likely to include a full-featured, and rather large, XML parser to interpret XML tags. Inclusion of the XML parser in the Control Point Stack further increases the size and complexity of the stack.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example Universal Plug and Play (UPnP) environment suitable for implementing enhanced control points, in accordance with one example embodiment of the invention;

FIG. 2 is a block diagram of an example control point generator architecture, in accordance with one example embodiment of the invention;

FIG. 3 is a flow chart of an example method for generating an enhanced control point, in accordance with one example embodiment of the invention; and

FIG. 4 is a flow chart of an example method of operation utilized by an enhanced control point, in accordance with one example embodiment of the invention.

### DETAILED DESCRIPTION

Embodiments of the present invention generally describe a method, apparatus and system for creating efficient Universal Plug and Play (“UPnP”) control points. In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same.

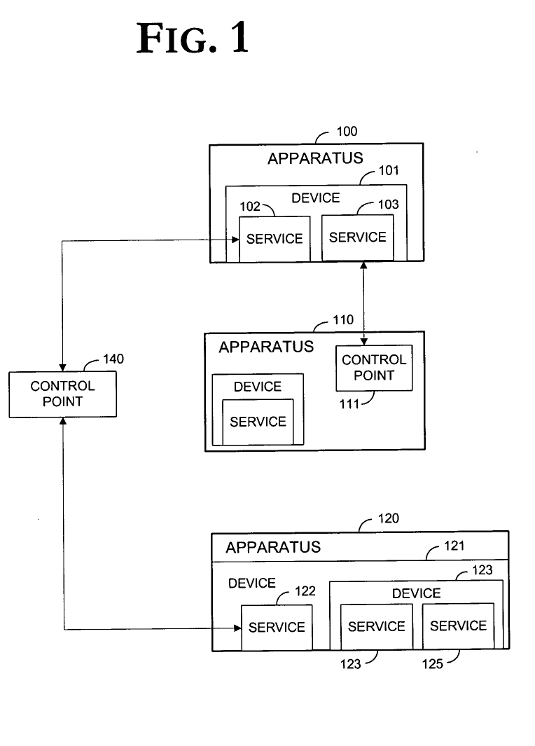

FIG. 1 is a block diagram of an example UPnP environment suitable for implementing enhanced control points, in accordance with one example embodiment of the invention. FIG. 1 illustrates apparatuses 100, 110, and 120, each of which may represent a unit, such as a personal computer, a television, a digital camera, or any other suitable unit. Each apparatus may include at least one device. As used herein, a device is an object that is abstracted within an apparatus. A device may contain services and/or other device objects. A service is an object that is abstracted within a device.

As shown in apparatus 100, an apparatus may include one or more device(s), and each device may include several services. In one example implementation, apparatus 100 is a video cassette recorder, device 101 is a video cassette recorder device, service 102 is a tape transport service, and service 103 is a tuner service. In contrast, apparatus 120 may be a combination television/video cassette recorder apparatus that includes television device 121 and tuner service 122. Television device 121 may also include videocassette recorder device 123 and its associated services 124 and 125.

The services provided by a particular type of device differ among device types. Accordingly, a device may maintain and selectively provide a listing of the service(s) and/or other information pertaining to the individual device. According to one example implementation, a device hosts an extensible Markup Language (XML) description document that describes the services provided by the device as well as other associated information.

Each service (102, 103, 122, for example) may expose actions to UPNP control points (111 and 140) and models its state using, e.g., state variables. As a particular example, a clock service may provide the actions get_time and set_time, and may model its state using the state variable current_time. The actions and state variables are described by an XML service description document. The aforementioned XML description document includes a pointer to the service description documents of its associated services.

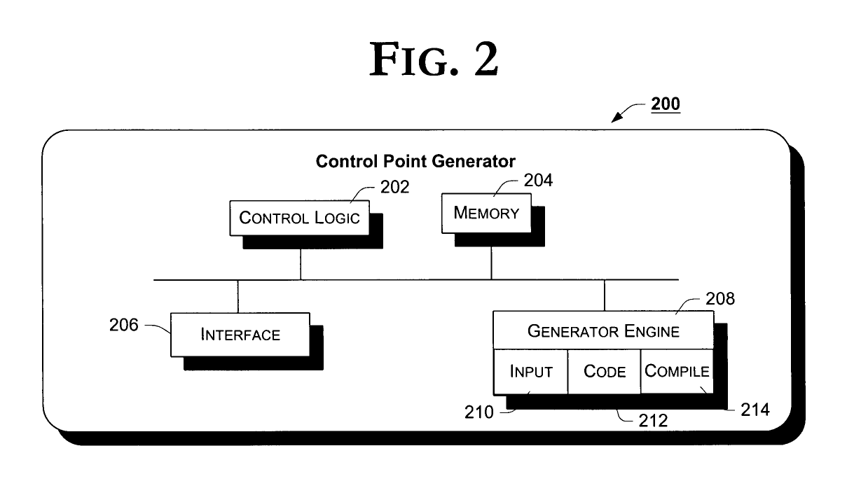

Control point 140 of FIG. 2 is shown in communication with service 102 and service 122. Control point 140 may be embedded in an apparatus such as control point 111 of apparatus 110. As shown, a control point may access actions of services that are embedded in disparate devices (and apparatuses).

A control point 140 may be used to discover and control devices in UPNP network 100. In some embodiments, control point 140 may discover a device, receive an XML description associated with the device, retrieve descriptions of services associated with the device based on pointers located in the description, invoke actions specified in the service descriptions, and subscribe to events issued by the services. In the latter regard, a service will send an event to the control point when a state of the service changes. A service description may also include a list of variables that model the state of the service at run time. UPnP-compliant messages may be delivered via Hyper Text Transport Protocol (“HTTP”) or User Datagram Protocol (“UDP”) or any other of a number of protocols, possibly running over Internet Protocol (“IP”).

FIG. 2 is a block diagram of an example control point generator architecture, in accordance with one example embodiment of the invention. As shown, control point generator 200 may include one or more of control logic 202, memory 204, interface 206, and generator engine 208 coupled as shown in FIG. 2. In accordance with one aspect of the present invention, to be developed more fully below, control point generator 200 includes a generator engine 208 comprising one or more of input services 210, code services 212, and/or compile services 214. It is to be appreciated that, although depicted as a number of disparate functional blocks, one or more of elements 202-214 may well be combined into one or more multi-functional blocks. Similarly, generator engine 208 may well be practiced with fewer functional blocks, i.e., with only code services 212, without deviating from the spirit and scope of the present invention. In this regard, control point generator 200 in general, and generator engine 208 in particular, are merely illustrative of one example implementation of one aspect of the present invention. As used herein, control point generator 200 may well be embodied in hardware, software, firmware and/or any combination thereof.

Control point generator 200 may create efficient control points. According to one embodiment of the present invention, instead of purchasing generic stacks and creating control point stacks, control point vendors may instead utilize control point generator 200 to generate an efficient UPnP control point (hereafter referred to as “enhanced control point”). An enhanced control point may be tailored to control specific devices with specific services for specific platforms, thus avoiding the unnecessary code found in a control point stack today. As a result, an enhanced control point may be significantly smaller (i.e. less memory required) and more efficient (i.e. faster responding) than a control point stack, because the enhanced control point may utilize a custom XML parser with a subset of the features of a fully featured XML parser. In one embodiment, the functionality of control point generator 200 may be performed by software within, or in cooperation with, an electronic appliance not depicted.

As used herein control logic 202 may provide the logical interface between control point generator 200 and others. In this regard, control logic 202 may manage one or more aspects of control point generator 200 to provide a communication interface from other devices and users to enhanced control points generated by control point generator 200. According to one aspect of the present invention, though the claims are not so limited, control logic 202 receives initialization event indications such as, e.g., a request to generate a control point. Upon receiving such an indication, control logic 202 selectively invokes the resource(s) of generator engine 208. As part of an example method for generating a control point, as explained in greater detail with reference to FIG. 4, control logic 202 may selectively invoke input services 210 and code services 212 that receive input on and generate code for, respectively, the desired control point. Control logic 202 may also selectively invoke compile services 214 to compile the generated control point code. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In alternate implementations, control logic 202 is intended to represent content (e.g., software instructions, etc.), which when executed implements the features of control logic 202 described herein.

Memory 204 is intended to represent any of a wide variety of memory devices and/or systems known in the art capable of storing control point code. According to one example implementation, though the claims are not so limited, memory 204 may well include volatile and non-volatile memory elements, possibly random access memory (RAM) and/or read only memory (ROM).

Interface 206 may provide a path through which control point generator 200 can communicate to, for example, receive control point target information. Interface 206 is intended to represent any of a wide variety of interfaces known in the art, and may include, but is not limited to, keyboards, mice, and network connections.

As introduced above, generator engine 208 may be selectively invoked by control logic 202 to receive control point target information, to generate code for the enhanced control point, and to compile the generated code. In accordance with the illustrated example implementation of FIG. 2, generator engine 208 is depicted comprising one or more of input services 210, code services 212 and compile services 214. Although depicted as a number of disparate elements, those skilled in the art will appreciate that one or more elements 210-214 of generator engine 208 may well be combined without deviating from the scope and spirit of the present invention.

Input services 210, as introduced above, provide control point generator 200 with the ability to receive control point target information. In one example embodiment, input services 210 may accept input from a programmer such as, for example, device(s) and/or service(s) and platform(s) descriptions pertaining to the desired control point. In an alternate embodiment, input services 210 may automatically acquire the necessary descriptions pertaining to the desired control point through communication with the target UPNP environment.

As introduced above, code services 212 provide control point generator 200 with the ability to generate code for the enhanced control point. Code services 212 may use device and/or service descriptions and/or platform specific information to generate custom source code and/or interfaces tailored to the enhanced control point. In one embodiment, code services 212 may include code necessary for a stated limited purpose of a control point, but may not include code that is not necessary for such a limited purpose. According to embodiments of the present invention, the enhanced control point may be generated using any programming language (e.g., C, C++, C#, Java, Visual Basic, etc.).

Compile services 214, as introduced above, provide control point generator 200 with the ability to compile the generated code. In one embodiment, compile services 214. According to embodiments of the present invention, the enhanced control point may be compiled for any operating system (e.g., Windows, Unix, Linux, etc.).

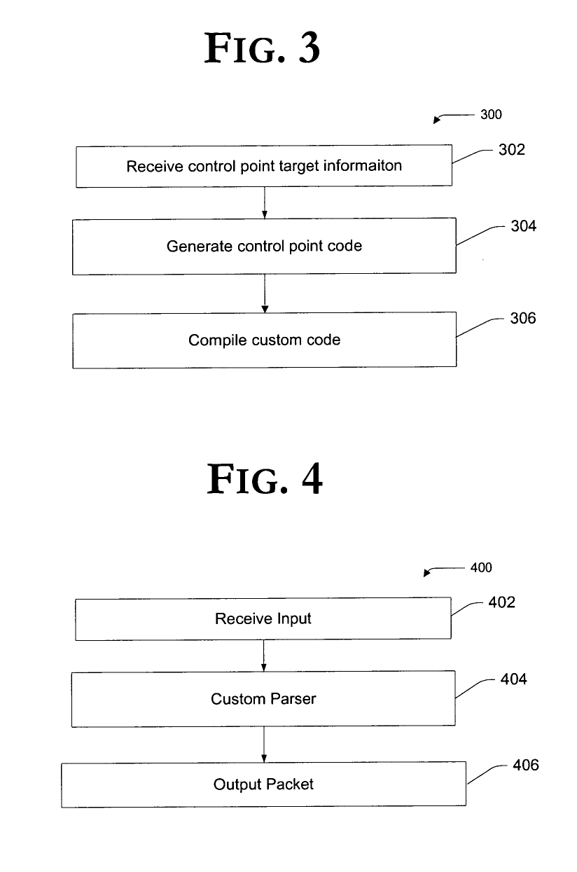

FIG. 3 is a flow chart of an example method for generating an enhanced control point, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention. As illustrated, descriptions for specific device(s), service(s), and/or platform(s), which make up the control point target information, are received (302) by input services 210. As an example, the control point target information for control point 140 may include descriptions for devices 101 and 121 and services 102 and 122.

Using the device and service descriptions and platform specific information, code services 212 may generate custom source code (304) and interfaces tailored to the enhanced control point. In one embodiment, the generated code may include a custom XML parser to parse only certain types of information and output only certain types of packets, based on the control point target information.

The custom source code and/or sample application may then be compiled (306) by compile services 214 to generate a custom application for the control point.

FIG. 4 is a flow chart of an example method of operation utilized by an enhanced control point, in accordance with one example embodiment of the invention, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

The enhanced control point may receive (402) input(s) from services and/or applications intending to control services. As an example, control point 111 may receive a communication from service 103.

The enhanced control point may then utilize a custom parser (404) to quickly process the input(s) received. In one embodiment, the custom parser may be able to process input(s) more quickly than a fully featured XML parser, because the custom parser may have a smaller code size as a result of the control point code generation (304).

The enhanced control point may then output (406) packet(s). In one embodiment, the output packets may be of a platform-specific type that may have been specified as part of the control point target information (302).

In the foregoing specification, embodiments of the invention have been described with reference to specific exemplary embodiments thereof. It will, however, be appreciated that various modifications and changes may be made thereto without departing from the broader spirit and scope of the embodiments of the invention as set forth in the appended claims. The specification and drawings are, accordingly, to be regarded in an illustrative rather than a restrictive sense.

What is claimed is:

1. A method, comprising:
accessing at least one of device-specific and/or platform information for a device that will implement a Universal Plug and Play (UPnP) control point; and
generating custom source code, tailored to the device, to efficiently implement the control point on the device based on at least one of the device-specific information and the platform information.

2. The method according to claim 1 further comprising compiling the source code to generate the UPnP control point.

3. The method according to claim 1 wherein accessing the device-specific information further comprises accessing at least one of a device description and a service description for the device.

4. The method according to claim 1 wherein accessing the device-specific information further comprises receiving device-specific information from a programmer.

5. The method according to claim 1 wherein generating the source code further comprises enhancing the source code for the control point.

6. The method according to claim 5 wherein enhancing the source code further comprises creating a custom eXtensible Markup Language (XML) parser.

7. A storage medium comprising content which, when executed by an accessing machine, causes the accessing machine to:
access at least one of device-specific information and/or platform information for a device that will implement a Universal Plug and Play (UPnP) control point; and
generate custom source code, tailored to the device, to efficiently implement the control point on the device based on at least one of the device-specific information and the platform information.

8. The storage medium according to claim 7 further comprising content which, when executed by the accessing machine, causes the accessing machine to compile the source code to generate the UPNP control point.

9. The storage medium according to claim 7 wherein the content to access the device-specific information comprises content which, when executed by the accessing machine, causes the accessing machine to access at least one of a device description and a service description for the device.

10. The storage medium according to claim 7 wherein the content to access the device-specific information comprises content which, when executed by the accessing machine, causes the accessing machine to receive device-specific information from a programmer.

11. The storage medium according to claim 7 wherein the content to generate the source code further comprises content which, when executed by the accessing machine, causes the accessing machine to enhance the source code for the control point.

12. The storage medium according to claim 11 wherein the content to enhance the source code further comprises content which, when executed by the accessing machine, causes the accessing machine to create a custom eXtensible Markup Language (XML) parser.

13. An apparatus, comprising:
a generator engine to access at least one of device-specific information and/or platform information for a device that will implement a Universal Plug and Play (UPNP) control point, and the generator engine to generate custom source code, tailored to the device, to efficiently implement the control point on the device based on at least one of the device-specific information and the platform information.

14. The apparatus according to claim 13 further comprising the generator engine to compile the source code to generate the UPnP control point.

15. The apparatus according to claim 13 further comprising the generator to generate source code based on at least one of a device description and a service description for the device.

16. The apparatus according to claim 14 further comprising the generator engine to generate source code to create a custom eXtensible Markup Language (XML) parser.

17. The apparatus according to claim 13 further comprising an interface coupled to the generator engine, the interface to receive device-specific information and platform information.

18. The apparatus according to claim 13 further comprising a memory coupled to the generator engine, the memory to store the source code.
